(19) United States
(12) Patent Application Publication
(10) Pub. No.: US 2006/0151082 A1
(43) Pub. Date: Jul. 13, 2006

(54) Self-sealing puncture proof tire

(76) Inventor: Elias De Los Santos, Las Pinas City (PH)

Correspondence Address: RICHARD E. NOVAK, CHESTNUT HILL PROFESSIONAL CENTER, 157 ENGLE STREET, ENGLEWOOD, NJ, 07631, US

(21) Appl. No.: 11/031,173

(22) Filed: Jan. 7, 2005

(51) Int. Cl. B60C 19/12

(52) U.S. Cl. 152/504

(57) ABSTRACT

A self-sealing puncture-proof pneumatic tubeless tire comprising a layer of soft non-cured gum rubber compound fixedly attached to the inner surface of the tire and a layer of soft textured nylon ply reinforced rubber secured by the adhesive effect of the non-cured gum rubber compound and vulcanized at the wire bead section of the tire, thereby enclosing the soft non-cured gum rubber compound.

### BACKGROUND OF THE INVENTION

This invention relates to self-sealing puncture-proof pneumatic tires of the tubeless type, and in particular to a self-sealing puncture-proof pneumatic tubeless tire which has a layer of soft non-cured gum rubber compound attached to the inner surface of the tire and a layer of soft textured nylon ply reinforced rubber adhering to the gum rubber compound and vulcanized at the wire bead section of the tire.

Tires are a critical part of any motor vehicle, and when a puncture causes a tire to lose air pressure a dangerous situation is created. A reliable means of retarding or stopping deflation caused by punctures has long been sought. This type of tire would reduce the frequency of tire changes on the road, resulting in an increased level of safety to the motoring public, and convenience to the driver who need not look immediately for a tire repair facility.

Various approaches to achieving self-sealing and puncture-proof tires have been proposed without commercial success. A proposal to use liners that plug a hole in the tire using the air pressure within the tires and the pressure of the tire on the road does not work if the hole is too large. A proposal to inject various compositions into a tire to seal punctures has the disadvantage that fibrous materials used in these sealants tend to clump and ball up prior to entering the puncture.

Puncture sealing tubeless tires have previously been proposed that contain a layer of sealant composition which has plastic and adhesive qualities, which allow the sealant to stick to a puncturing object and when the object is withdrawn, flow into the opening or puncture forming a plug which seals the puncture, retarding or eliminating the loss of air pressure. Unfortunately, it has been difficult to provide a sealant of sufficient and appropriate viscosity to prevent it from flowing out of the puncture at the elevated temperature and air pressure found in tires under normal operating conditions. Patents employing unvulcanized, partially vulcanized or fully vulcanized elastomeric layers encounter the same problems.

In the present invention, the self sealing means maintains sufficient and appropriate viscosity to seal the puncture.

### SUMMARY OF THE INVENTION

It is therefore an object of the present invention to provide a self-sealing puncture-proof tire that automatically closes a hole or puncture in the tire.

It is a further object of the present invention to provide a self-sealing puncture-proof tire wherein the self-sealing puncture-proof means forms an integral part of the tire, and the self-sealing layer is approximately ⅜ inch thick, more or less depending on the size of the tire, enabling the tire to close the puncture so that the tire does not deflate when punctured. Punctures caused by road hazards such as nails and glass, and even bullet holes would be automatically closed by the novel self-sealing puncture-proof tire.

Other objects and advantages of the present invention will become apparent and be easily understood upon reading the detailed description taken in conjunction with the enclosed drawings.

### BRIEF DESCRIPTION OF THE DRAWINGS

FIG. 1 is a perspective view of the self-sealing puncture proof tire.

FIG. 2 is a cross-sectional view of the self-sealing puncture proof tire.

### DETAILED DESCRIPTION OF THE INVENTION

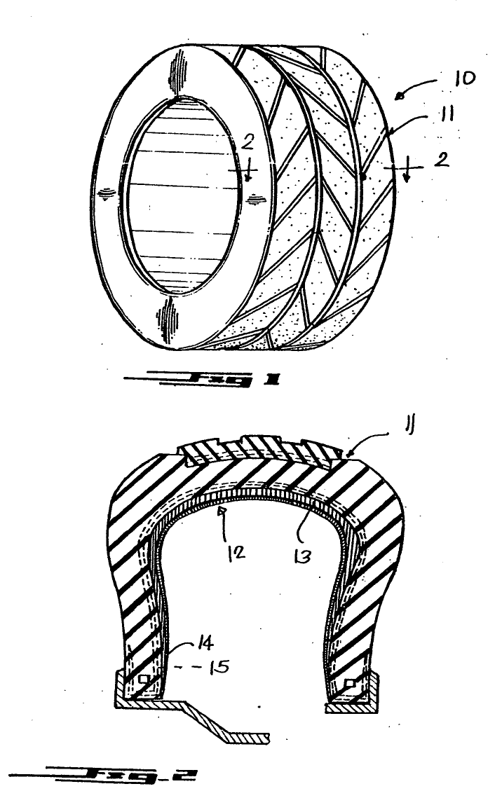

During the course of this description like numerals will be used to identify like elements according to the different figures which illustrate the invention. One embodiment of the present invention is shown in FIGS. 1 and 2. A self-sealing puncture proof tire is designated generally by the numeral 10.

Pneumatic tires generally consist of a flexible-cord carcass or body to resist the pressure of the inflation gas, terminated at each side edge by a bead which engages the rim of a wheel. The cords are embedded in rubber and are protected from abrasion by tread and sidewall rubber, and are made to hold air by preferably having an integral, essentially impervious liner on the interior of the carcass.

In the drawing, FIG. 1, self-sealing puncture proof tire 10 comprises a conventional tire 11 and a self-sealing puncture-proofing means 12 attached to the inner surface of tire 10.

Self-sealing puncture-proofing means 12 is comprised of a layer of soft non-cured gum rubber compound 13, which is first adhered to the inner surface of tire 11 and a layer of soft textured nylon ply reinforced rubber 14 which pushes the non-cured gum rubber compound 13 into the puncture and closes it.

Self-sealing puncture-proofing means 12 is preferably ¼ inch thick for the soft non-cured gum rubber compound 13 and ⅛ inch thick for the soft textured, nylon ply reinforced hard rubber 14.

It is to be understood that variations and modifications of the present invention may be made without departing from the scope thereof. It is also to be understood that the present invention is not to be limited by the specific embodiments disclosed herein, but only in accordance with the appended claims when read in light of the foregoing specification.

What is claimed is:

1. A self-sealing puncture-proof pneumatic tubeless tire comprising a conventional tire and a self-sealing puncture-proof means fixedly attached at the inner surface of said tire, said self-sealing puncture-proof means comprised of a layer of soft non-cured gum rubber compound, which is adhered to said inner surface of said tire, and a layer of soft textured nylon ply reinforced rubber secured by the adhesive effect of the non-cured gum rubber compound and vulcanized at the wire bead section of the tire, thereby enclosing said soft non-cured gum rubber compound.
